(19) United States
(12) Patent Application Publication
(10) Pub. No.: US 2008/0225510 A1
(43) Pub. Date: Sep. 18, 2008

(54) SPEAKER ASSEMBLY

(75) Inventor: Jeffrey Alan Rocha, Paxton, MA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: LOUD TECHNOLOGIES INC, Woodinville, WA (US)

(21) Appl. No.: 12/033,812

(22) Filed: Feb. 19, 2008

Related U.S. Application Data
(60) Provisional application No. 60/980,688, filed on Oct. 17, 2007.
(60) Provisional application No. 60/890,402, filed on Feb. 16, 2007.

(51) Int. Cl. H04M 1/22; H04R 1/02

(52) U.S. Cl. 362/86; 381/386

(57) ABSTRACT

A speaker assembly (20) for use with a light bulb socket is provided. The speaker assembly generally includes a housing (22) including an electrical contact (26) for use with a light bulb socket for supplying electrical power to the housing. The speaker assembly further includes a receiver, an amplifier, and a speaker (24) being disposed within and electrically connected to the housing, wherein the receiver receives an audio signal and delivers it to the amplifier, and wherein the amplifier amplifies the signal for delivery to the speaker.

### CROSS-REFERENCES TO RELATED APPLICATIONS

The application claims the benefit of U.S. Provisional Application No. 60/980,688, filed Oct. 17, 2007, and U.S. Provisional Application No. 60/890,402, filed Feb. 16, 2007, the disclosures of which are hereby expressly incorporated by reference.

### TECHNICAL FIELD

The present disclosure relates generally to speaker assemblies and, more specifically, to speaker assemblies designed for use with light bulb sockets.

### BACKGROUND

The demand for “invisible” loudspeaker systems in homes and businesses has driven the consumer and professional audio industries to design less obtrusive products that are more readily integrated into home and business environments. These products include speakers designed to look like other non-speaker objects, very small speakers, and speakers that can be installed in walls and ceilings. Many designers (including homeowners, business owners, and architects) still find these products too conspicuous or unsuitable for their individual tastes and requirements. They may also consider the acoustical compromises required to implement some of these designs unacceptable and the complexity of installation for these devices excessive. In view of such difficulties, designers may simply forego sound system installation.

Most of these same homeowners and professionals, however, are willing to integrate visible lighting fixtures into the aesthetics of their spaces. This acceptance may be in large part due to the lighting industry's willingness to design and manufacture an astounding array of product options. In that regard, almost any style can be reflected by at least one of the available lighting alternatives. Additionally, the relative simplicity of installation and the availability of trained professional installers make lighting implementation simple.

Relative to the scope of available light fixture options, the number of available light bulb package sizes and by extension, light bulb socket sizes, has generally been standardized. It is therefore advantageous to design a loudspeaker system that leverages off of light bulb standardization to provide a product that is as inconspicuous and simple to install as a light bulb. Thus, there exists a need for a quality loudspeaker that is compatible with a standard light bulb socket.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a speaker assembly for use with a light bulb socket is provided. The speaker assembly generally includes a housing including an electrical contact for use with a light bulb socket for supplying electrical power to the housing. The speaker assembly further includes a receiver, an amplifier, and a speaker disposed within and electrically connected to the housing, wherein the receiver receives an audio signal and delivers it to the amplifier, and wherein the amplifier amplifies the signal for delivery to the speaker. The speaker assembly further includes a light source disposed within and electrically connected to the housing, wherein the speaker is at least partially surrounded by the light source.

In accordance with one embodiment of the present disclosure, a speaker assembly or use with a light bulb socket is provided. The speaker assembly generally includes a housing having a base portion and a cover portion releasably coupleable to the base portion, the base portion including an electrical contact for use with a light bulb socket for supplying electrical power to the base portion. The speaker assembly further includes a receiver, an amplifier, and a speaker disposed within and electrically connected to the housing, wherein the receiver receives an audio signal and delivers it to the amplifier and wherein the amplifier amplifies the signal for delivery to the speaker, the receiver and the amplifier being electrically connected to the base portion and the speaker being electrically connected to the cover portion. The speaker assembly further includes means for supplying electrical power from the base portion to the cover portion.

### DESCRIPTION OF THE DRAWINGS

The foregoing aspects and many of the attendant advantages of this disclosure will become more readily appreciated by reference to the following detailed description, when taken in conjunction with the accompanying drawings, wherein:

FIG. 1 is a perspective view of a speaker assembly in accordance with one embodiment of the present disclosure configured for a spiral-type compact fluorescent light (CFL) light source;

FIG. 2 is an exploded view of a speaker assembly of FIG. 1;

FIG. 3 is an exploded view of a speaker assembly in accordance with another embodiment of the present disclosure also configured for a spiral-type CFL light source;

FIG. 4 is an exploded view of a speaker assembly of FIG. 3;

FIG. 5 is a perspective view of a speaker assembly in accordance with another embodiment of the present disclosure configured for a U-shaped bulb CFL light source;

FIG. 6 is an exploded view of the speaker assembly of FIG. 5; and

FIG. 7 is a perspective view of a speaker assembly in accordance with another embodiment of the present disclosure configured for a ring light emitting diode (LED) light source.

### DETAILED DESCRIPTION

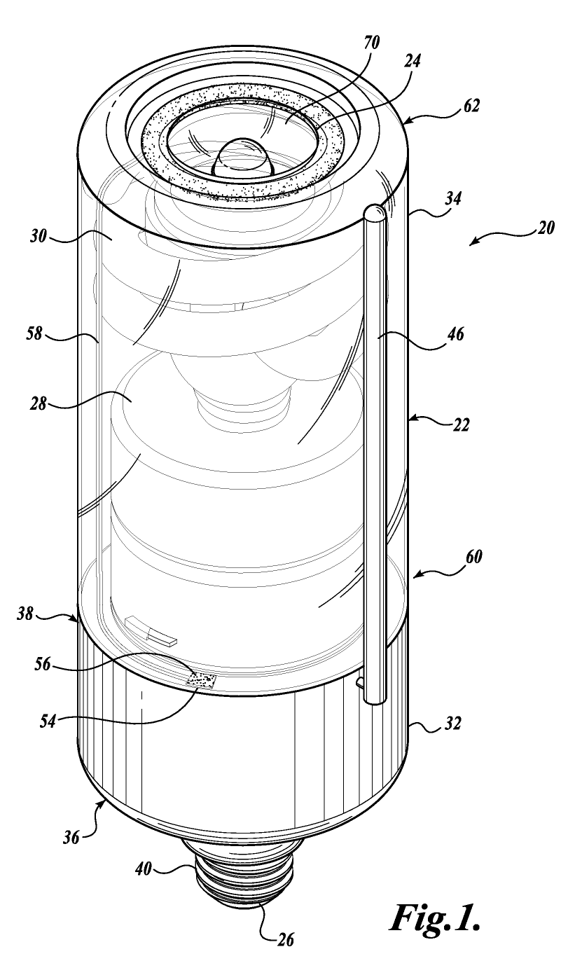

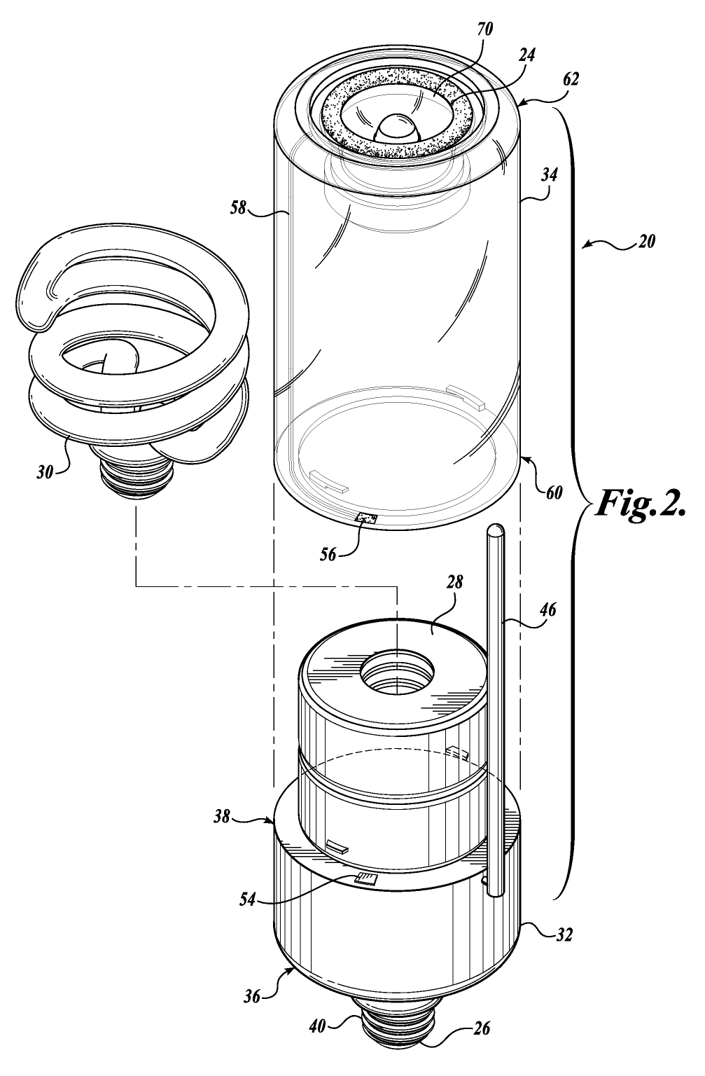

Embodiments of the present disclosure are generally directed to speaker assemblies designed for use with light bulb sockets. Referring to FIGS. 1 and 2, there is shown a speaker assembly 20 constructed in accordance with one embodiment of the present disclosure. The speaker assembly 20 generally includes a housing 22 and a speaker 24 disposed within and electrically connected to the housing 22. The housing 22 has an electrical contact 26 for use with a light bulb socket (not shown) of a conventional light fixture, such that the electrical contact 26 supplies electrical power to the housing 22 and, in turn, to the speaker 24 to power the speaker. The speaker assembly 20 is therefore configured to provide simple and convenient installation of a powered speaker in a standard light bulb socket.

The speaker assembly 20 in the illustrated embodiment of FIG. 1 is designed and configured to operate as both a speaker and as a source of light. It should be appreciated, however, that while the speaker assembly 20 may be configured to operate as both a speaker and a source of light, it may also be configured to operate solely as a speaker. The speaker assembly 20 includes means for an electrical connection, such as a ballast 28, shown as a light bulb socket, for optionally powering a light source 30, such as a light bulb. As seen in FIG. 1, the ballast 28 may be disposed within a base portion 32 of the housing 22, as described in greater detail below. The light source connection means may be any suitable light bulb ballast 28, such that the light source 30 can be replaced if needed. For example, if the light source 30 burns out, the old light bulb can be unscrewed from the ballast 28, and a new light bulb can be installed.

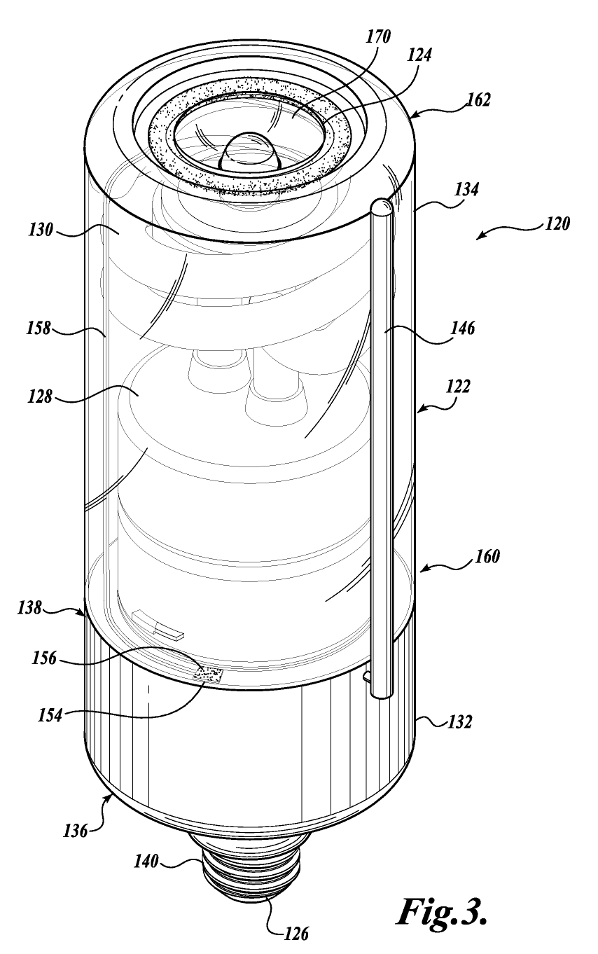

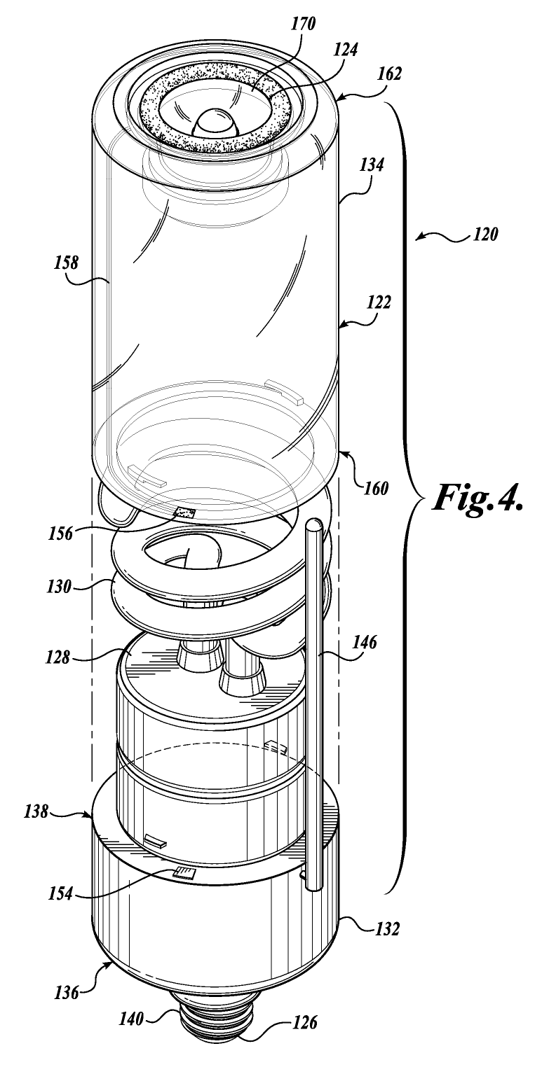

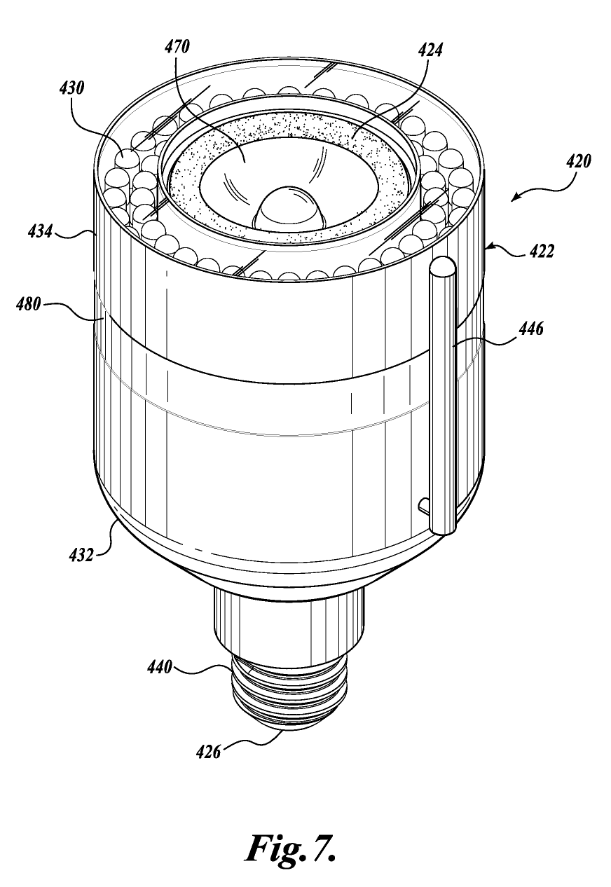

Referring to another embodiment in FIGS. 3 and 4, for which numeral references of like elements of the speaker assembly are similar, but are in the 100 series, the light source may be hard-wired into the ballast 128, for example, as a non-replaceable light source, such that if the light source burns out, the speaker assembly 120 can be replaced. As will be described in greater detail below, the light source used with the embodiments described herein may be a compact fluorescent lighting (CFL) light source (see FIGS. 1-6), a light emitting diode (LED) light source (see FIG. 7), or an incandescent light source (not shown).

In accordance with embodiments of the present disclosure, the speaker 24 may be a full-range, 2-inch transducer similar to computer speakers products and home theater cube speakers. It should be appreciated that this embodiment may be frequency limited, thus requiring subwoofers for reproducing dynamic full-range audio. In other embodiments, the speaker may be a larger format (type R or larger PAR designs) having a larger co-axial transducer capable of true full-range reproduction. It should be appreciated that embodiments of the present disclosure may be modularized such that alternate speaker types could be selected for different speaker assemblies.

The speaker assembly 20 of the illustrated embodiment is generally designed as a “receiver” element, configured for receiving an audio signal. However, it should be appreciated that an assembly may also include or be in communication with a discrete “transmitter” element, which accepts line level audio input and broadcasts a signal on numerous wireless channels to be received by “receiver” elements. In that regard, it should further be appreciated that a single “transmitter” element may transmit a signal that can be received by multiple speaker assemblies, or “receiver” elements. In this manner, it is possible to locate multiple speaker assemblies in a space, all receiving signals from a single “transmitter” element.

The speaker assembly 20 includes a receiver (not shown) for receiving an audio signal. The receiver receives an audio signal and sends it to an amplifier (not shown). In one embodiment of the present disclosure, the receiver is disposed within the base portion 32 of the housing 22. The receiver is preferably an integrated wireless receiver with multiple carrier frequency selection to allow audio that is sent from a transmitter on a given frequency to be received by the speaker assembly 20, when set to the same frequency, and delivered to an amplifier input. In that regard, the speaker assembly 20 may be configured so as to allow a user to change between frequencies to receive different signals. Such reception may be enhanced by the use of an optional antenna 46.

Although preferably an integrated wireless receiver, it should be appreciated that the receiver may be configured for any format that supports audio transmission, for example, including but not limited to, wireless transmission and reception, modulated audio sent over the AC power line, and a direct wired connection or plug-in to the speaker assembly. In addition, it should be appreciated that the audio input can be modularized, allowing for user selection of an appropriate platform. As one non-limiting example, the speaker assembly 20 may include a wireless receiver connectable to a PC-based USB input.

As mentioned above, the speaker 24 is a powered speaker and therefore the speaker assembly 20 includes an amplifier (not shown). The amplifier may be an integrated power amplifier that receives an input from, for example, a wireless receiver and amplifies the signal for appropriate delivery to the speaker. In one embodiment of the present disclosure, the amplifier may be disposed within the base portion 32 of the housing 22 and powered by the electrical contact 26 when used with a light bulb socket.

The housing 22 is designed to house the speaker 24 and/or the light source 30, as well as other components of the assembly 20, and to provide protection for the same. As described in greater detail below, the housing 22 may also be designed to enhance the acoustics and/or the lighting quality of the assembly 20. In that regard, the speaker assembly 20 may be designed such that neither the speaker 24 nor the light source 30 substantially interferes with or substantially blocks the sound or the light of the other.

The housing 22 may be configured to be openable, so as to allow access to its interior, for example, for internal adjustment of the speaker assembly 20 or replacement of the light source 30. In the illustrated embodiment of FIG. 1, the housing 22 includes a base portion 32 and a cover portion 34, the cover portion 34 being coupleable to the base portion 32. When the base portion 32 and the cover portion 34 are coupled to one another as a housing 22, the housing 22 forms an enclosure for the speaker 24 and the light source 30, as well as other components of the assembly 20. It should be appreciated that the cover portion 34 may be releasably coupleable to the base portion 32. In that regard, the base portion 32 and the cover portion 34 may include suitable mating interfaces that are configured for releasable nesting, such as mating twist-and-lock interfaces, magnetic interfaces, etc.

The base portion 32 serves as a base for the assembly 20 and supports the electrical contact 26 and other various components of the assembly 20. For example, the base portion 32 may include wiring components to provide power from the electrical contact 26 to the various components of the assembly 20. In that regard, the base portion 32 may include one or more electrical connections, for example, to the speaker 24, the amplifier (not shown), and the light source 30.

The electrical connections of the speaker assembly 20 will now be described in greater detail. Referring to FIGS. 1 and 2, the base portion 32 includes a first end 36 and a second end 38. At the first end 36, the base portion 32 includes an electrical contact 26 for use with a light bulb socket. In the illustrated embodiment, the electrical contact 26 of the base portion 32 includes a socket fitting 40, such as a metal screw base, compatible with standard domestic and international light sockets. However, it should be appreciated that other electrical contacts and other socket fittings are within the scope of the present disclosure.

In one embodiment of the present disclosure, the base portion 32 may include at least first and second base electrical connections (not shown), which may be wire connections. A first base electrical connection extends from the electrical contact 26 at the first end 36 of the base portion 32 to the second end 38 of the base portion 32. At the second end 38, the base portion 32 includes a base terminal 54 to provide electrical connection between the first base electrical connection and a cover electrical contact 56 to provide power to the cover portion 34 and, in turn, to the speaker 24, as described in greater detail below. It should be appreciated that the first base electrical connection also provides a connection between the receiver (not shown) and the amplifier (not shown) located in the base portion 32, and the speaker 24 located in the cover portion 34.

A second base electrical connection extends from the electrical contact 26 in the base portion 32 to the ballast 28 to supply electrical power to the ballast 28 for the light source 30. As described above, the base electrical connections are configured to be independent of one another to provide independent electrical connectability to the base terminal 54 and the ballast 28. Although described as separate first and second electrical connections, it should be appreciated that a coupled electrical connection for the speaker 24 and the light source 30 is also within the scope of the present disclosure. It should further be appreciated that additional electrical connections beyond first and second base electrical connections, whether independent or coupled, are also within the scope of the present disclosure.

The speaker assembly 20 may include suitable controls for the speaker 24 and the light source 30. If the electrical connections are configured to be independent of one another, then the speaker 24 and the light source 30 may have independent controls. For example, the speaker 24 may be on when the light source 30 is either on or off, and vice versa. In addition to on and off control, a suitable control system may include other controls, such as sound volume, light dimming, and speaker receiver channel control. Such controls may be located on the speaker assembly 20. As a non-limiting example, the cover portion 34 or the base portion 32 may be configured to be rotatable relative to the other, such that rotation would turn the speaker 24 or the light source 30 either on or off, or would control sound volume, light dimming, and speaker receiver channel.

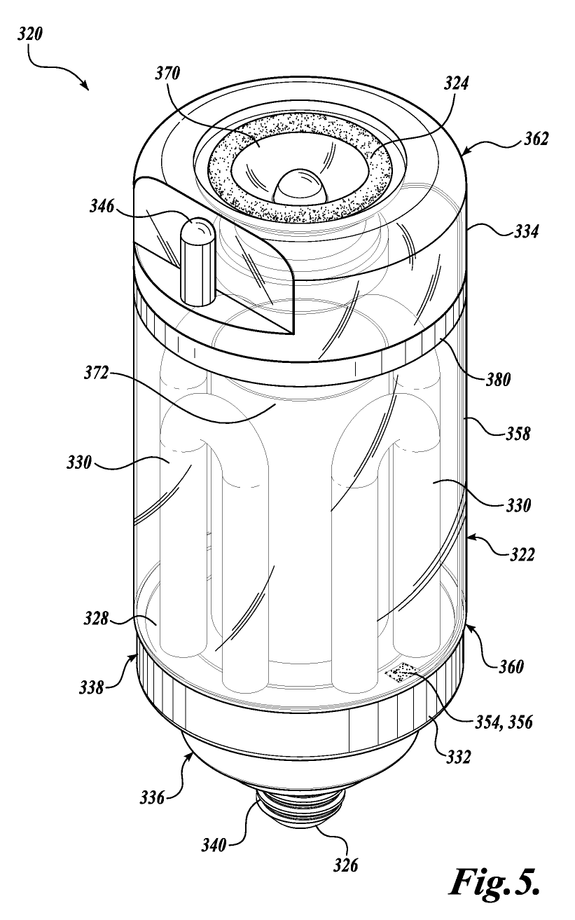

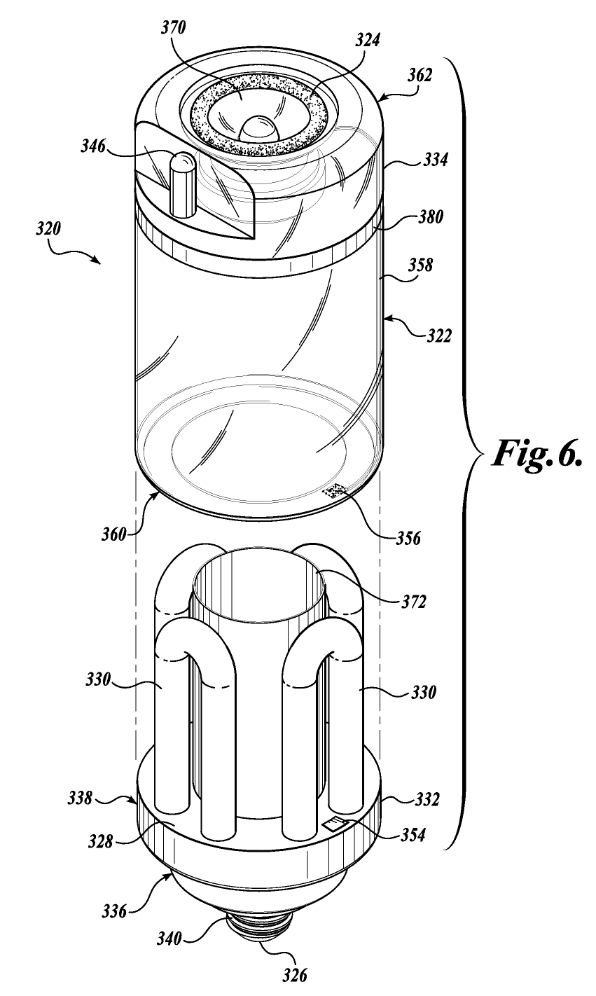

As another non-limiting example, the cover portion may include a movable or rotatable band 380 (see FIGS. 5 and 6) or 480 (see FIG. 7) on an exterior surface of the cover portion 334 (see FIGS. 5 and 6) or 434 (see FIG. 7) that can be rotated relative to the cover portion 334 or 434, for example, to a plurality of click stops, to control assembly variables. As yet another non-limiting example, control buttons may be located on the housing, such as a receiver channel control button, including an LED screen to display the selected channel number. In addition, it should be appreciated that such controls may be included in a remote device, such as a hand-held remote control device including an infrared receiver configured for suitable control of the speaker assembly.

The cover portion 34 supports the speaker 24 and provides protection to the speaker 24 and the light source 30, as well as other components of the assembly 20. In the illustrated embodiment, the cover portion 34 is a substantially cylindrical portion of the housing having a substantially constant circular cross section along the length of cover portion 34. However, it should be appreciated that other shapes besides substantially cylindrical, for example, cross sections of various types, such as rectangular, triangular, or other polygons, that are either constant or vary along the length of the cover portion, are also within the scope of the present disclosure.

The cover portion 34 has a first end 60, and a second end 62 distal from the first end 60. The first end 60 is a substantially open end that is designed to be proximate the base portion 32 and coupleable thereto. As described above, the first end 60 of the cover portion 34 may be releasably coupleable to the base portion 32 by a suitable connection mechanism. Due to the openness of the second end 62, components of the speaker assembly 20 can be received within the interior of the housing 22. As seen in the illustrated embodiment of FIG. 1, the light source 30, ballast 28, and other components are all disposed within the housing 22 when the base portion 32 and the cover portion 34 are coupled to one another.

In the illustrated embodiment of FIG. 1, the speaker 24 is mounted at the second end 62 of the cover portion 34 to optimize the sound delivered from the assembly 20. In that regard, the speaker 24 is mounted at the second end 62 of the cover portion 34 such that sound is emitted outwardly from the second end 42 of the cover portion 34. In a suitable embodiment, the speaker 24 may be removably mounted to the second end 62 of the cover portion 34, such as by a snap fit or other removable mounting, so as to be replaceable. In another suitable embodiment, the speaker 24 may be rigidly adhered or molded to the second end 62 of the cover portion 34. In the illustrated embodiment, the speaker 24 is mounted forward of the light source 30 so as to prevent any interference or shadowing of the acoustics delivered from the speaker 24 by the light source 30. As mentioned above, the housing 22 may be designed to enhance the acoustics and/or lighting quality of the assembly 20.

As mentioned above, the cover portion 34 also includes a cover electrical contact 56 to provide power to the speaker 24. In the illustrated embodiment of FIG. 1, the cover electrical contact 56 is located at the first end 60 of the cover portion 34 and connects to an electrical connection 58 embedded in the cover portion 34. The cover electrical connection 58 extends from the first end 60 to the second end 62. At the first end 60 of the cover portion 34, the cover electrical contact 56 is configured to mate with the base terminal 54 at the second end 38 of the base portion 32 when the base portion 32 and cover portion 34 are coupled together. When joined, the cover electrical contact 56 and the base terminal 54 align to form an electrical connection that delivers power from the electrical contact 26 disposed within the base portion 32 to the second end 62 of the cover portion 34. Such electrical power is transmitted to the speaker 24 and can be used to power the same by providing a connection between the speaker 24 and the receiver (not shown) and the amplifier (not shown), both the receiver and the amplifier being located in the base portion 32.

Although illustrated as a mating terminal connection between the base portion 32 and the cover portion 34, it should be appreciated that the speaker 24 may optionally be wired by one continuous electrical contact or wire extending from the base portion 32 to the speaker 24. In such an embodiment, however, care would need to be taken to avoid contact of the wiring with the light source 30 and to prevent dislocation of the wiring during disassembly of the housing 22, for example, to replace a burned out light source 30.

In the illustrated embodiment of FIG. 1, the speaker 24 is substantially centered relative to the light source 30, so as to allow at least a portion of the light emitted from the light source 30 to pass around the outer perimeter of the speaker 24 and outwardly from the second end 62 of the cover portion 34. In that regard, the light source 30 is a compact fluorescent lighting (CFL) spiral-type bulb that has been specially designed to provide light in surrounding relationship with the speaker 24. As seen in the illustrated embodiment, the CFL spiral-type bulb has a hollow center without obstruction, such that a portion of the speaker 24, such as the speaker driver, can fit within the center of the spiral-type bulb. In this manner, the CFL spiral-type bulb diffuses light around the outer perimeter of the speaker 24, such that light diffuses from the second end 62 of the cover portion 34.

In addition to the speaker 24 being substantially centered relative to the light source 30, the housing 22 and the speaker 24 may further be designed to allow for maximum light diffusion from the assembly 20. In that regard, at least a portion of the housing 22 may be translucent so as to allow light from the light source 30 to pass through the housing 22. As seen in the illustrated embodiment of FIG. 1, the cover portion 34 is configured as being entirely translucent. It should be appreciated, however, that any portion of the housing 22 or the cover portion 34 may be translucent so as to desirably diffuse light. For example, if light is preferably directed to one side of the housing 22, then only that side need be configured as translucent. If light is preferably directed from the second end 62 of the cover portion 34, then only the second end 62 of the cover portion 34 need be configured as translucent. At least a portion of the housing 22 may further be semitransulent to reduce shadowing in the housing 22.

Moreover, at least a portion of the speaker 24 may also be configured as translucent or semitranslucent so as to allow light from the light source 30 to pass through the speaker 24. As a non-limiting example, the cone 70 of the speaker 24 may be configured as a translucent or semitranslucent portion of the speaker 24.

In the illustrated embodiment, the speaker 24 is positioned to emit sound outwardly from the second end 62 of the cover portion 34. Therefore, the light source 30 does not interfere or shadow the sound from the speaker 24. However, it should be appreciated that in other embodiments of the present disclosure, the speaker may be disposed within the housing and/or the light source may be positioned in front of the speaker. As a non-limiting example, the speaker may be disposed within the base portion of the housing and the light source may be disposed within the cover portion of the housing. In these embodiments, it should be appreciated that the housing may be acoustically designed as a speaker enclosure to enhance acoustic quality and/or to minimize the shadowing effects of the light source, if in front of the speaker. Moreover, it should be appreciated that in other embodiments, the speaker may be affixed to the housing by an adjustable mounting device, such as a rotating mount or a mechanical arm, so as to allow a user to position or aim the audio output from the speaker assembly.

Now referring to FIGS. 5-7, speaker assemblies designed for use with light bulb sockets in accordance with other embodiments of the present disclosure will be described in greater detail. The assemblies are substantially identical in materials and operation as the previously described embodiments, except for differences regarding the light source, which will be described in greater detail below. For clarity in the ensuing descriptions, the numeral references of like elements of the speaker assembly are similar, but are in the 300 series for the illustrated embodiment of FIGS. 5 and 6, and in the 400 series for the illustrated embodiment of FIG. 7.

In the illustrated embodiment of FIGS. 5 and 6, the light source 330 is a U-shaped CFL bulb. Similar to the first embodiments, the light source 330 of FIGS. 5 and 6 is also configured to provide light in surrounding relationship with the speaker 324. In that regard, the CFL U-shaped bulb has a hollow center without obstruction, such that a portion of the speaker 324, such as the speaker coil, can fit within the center of the bulb 330 to diffuse light around the outer perimeter of the speaker 324 and from the second end 362 of the cover portion 334. Moreover, the speaker 324 is substantially centered relative to the light source 330. In the illustrated embodiment, the light source 330 further includes a reflective tube 372 substantially centered relative to the CFL tubes of the U-shaped bulb to provide reflective light advantages.

Referring now to FIG. 7, the light source 430 is a ring of LED lights. Also similar to the first embodiments, the light source 430 of FIG. 7 is also configured to provide light in surrounding relationship with the speaker 424. In that regard, the LED lights are configured in a ring having a hollow center without obstruction, such that a portion of the speaker 424, such as the speaker coil, can fit within the center of the bulb 430 to diffuse light around the outer perimeter of the speaker 424 and from one end of the housing 422. Moreover, the speaker 424 is substantially centered relative to the light source 430. The housing 422 in the illustrated embodiment is not configured as a translucent housing 422, because the LED lights are aligned to diffuse in a particular direction. However, it should be appreciated that the assembly 420 may be configured to include a translucent housing and LED lights configured for diffusion in a plurality of directions. Further concerning this embodiment, it should be appreciated that LED lights may tend to burn hotter than other light sources; and therefore, a light cooling device may be configured for this embodiment to prevent overheating of the light source.

While illustrative embodiments have been illustrated and described, it will be appreciated that various changes can be made therein without departing from the spirit and scope of the disclosure.

The embodiments of the disclosure in which an exclusive property or privilege is claimed are defined as follows:

1. A speaker assembly for use with a light bulb socket, the assembly comprising:
(a) a housing including an electrical contact for use with a light bulb socket for supplying electrical power to the housing;
(b) a receiver, an amplifier, and a speaker disposed within and electrically connected to the housing, wherein the receiver receives an audio signal and delivers it to the amplifier, and wherein the amplifier amplifies the signal for delivery to the speaker; and
(c) a light source disposed within and electrically connected to the housing, wherein the speaker is at least partially surrounded by the light source.

2. The speaker assembly of claim 1, wherein the base portion further includes a ballast configured for releasably receiving an electric current to power a light source.

3. The speaker assembly of claim 2, wherein the light source is disposed within and electrically connected to the housing, such that light diffuses from the housing when powered by the ballast.

4. The speaker assembly of claim 1, wherein at least a portion of the speaker is surrounded by the light source so as to allow at least a portion of the light from the light source to diffuse from an end of the housing.

5. The speaker assembly of claim 1, wherein the speaker is substantially centered relative to the light source.

6. The assembly of claim 1, wherein the light source is selected from the group consisting of a CFL light source, an LED light source, and an incandescent light source.

7. The speaker assembly of claim 1, wherein at least a portion of the housing is translucent to permit light to diffuse through the housing.

8. The speaker assembly of claim 1, wherein at least a portion of the speaker is translucent to permit light to diffuse through the speaker.

9. The assembly of claim 1, wherein the electrical contact is configured to supply electrical power to the speaker and the light source.

10. The assembly of claim 9, wherein the electrical connectability between the speaker and the electrical contact is independent of the electrical connectability of the light source and the electrical contact.

11. The assembly of claim 1, wherein the receiver is a wireless receiver.

12. A speaker assembly for use with a light bulb socket, the assembly comprising:
(a) a housing having a base portion and a cover portion releasably coupleable to the base portion, the base portion including an electrical contact for use with a light bulb socket for supplying electrical power to the base portion;
(b) a receiver, an amplifier, and a speaker disposed within and electrically connected to the housing, wherein the receiver receives an audio signal and delivers it to the amplifier and wherein the amplifier amplifies the signal for delivery to the speaker, the receiver and the amplifier being electrically connected to the base portion and the speaker being electrically connected to the cover portion; and
(c) means for supplying electrical power from the base portion to the cover portion.

13. The speaker assembly of claim 12, wherein the base portion further includes a ballast configured for receiving an electric current to power a light source.

14. The speaker assembly of claim 13, wherein the light source is disposed within and electrically connected to the housing, such that light diffuses from at least the cover portion when powered by the ballast.

15. The speaker assembly of claim 13, wherein at least a portion of the speaker is surrounded by the light source so as to allow at least a portion of the light from the light source to diffuse from an end of the cover portion.

16. The speaker assembly of claim 14, wherein the speaker is substantially centered relative to the light source.

17. The assembly of claim 13, wherein the light source is selected from the group consisting of a CFL light source, an LED light source, and an incandescent light source.

18. The speaker assembly of claim 13, wherein at least a portion of the cover portion is translucent to permit light from the light source to diffuse through the cover portion.

19. The speaker assembly of claim 13, wherein at least a portion of the speaker is translucent to permit light from the light source to diffuse through the speaker.

20. The assembly of claim 13, wherein the electrical contact is configured to supply electrical power to the speaker and the ballast.

21. The assembly of claim 20, wherein the electrical connectability between the speaker and the electrical contact is independent of the electrical connectability of the ballast and the electrical contact.

22. The assembly of claim 12, wherein the receiver is a wireless receiver.
